(19) United States
(12) Patent Application Publication
(10) Pub. No.: US 2026/0030812 A1
(43) Pub. Date: Jan. 29, 2026

(54) METHOD AND APPARATUS FOR EFFECT PROCESSING, AND STORAGE MEDIUM

(71) Applicant: Beijing Zitiao Network Technology Co., Ltd., Beijing (CN)

(72) Inventors: Yiding WANG, Beijing (CN); Bowen CHEN, Beijing (CN)

(21) Appl. No.: 19/279,935

(22) Filed: Jul. 24, 2025

(30) Foreign Application Priority Data
Jul. 24, 2024 (CN) 202411000986.2

(51) Int. Cl. G06T 11/60; G06T 7/11; G06T 7/70; G06T 11/00; G06T 11/40

(52) U.S. Cl. CPC G06T 11/60; G06T 7/11; G06T 7/70; G06T 11/001; G06T 11/40; G06T 2207/30196

(57) ABSTRACT

A method and an apparatus for effect processing, and a storage medium are provided. The method includes: in response to an image setting operation, acquiring multiple first images, the multiple images including at least two content reference images and a posture reference image, and the posture reference image including multiple first objects; and in response to an effect triggering operation, generating an effect image according to the content reference images and the posture reference image, wherein the effect image includes a multiple effect objects, at least a portion of an object content in the multiple effect objects is associated with at least a portion of an image content in the content reference images, and posture information of each of the multiple effect objects is associated with posture information of one of the multiple first objects.

### CROSS-REFERENCE TO RELATED APPLICATION

The present application claims the priority of the Chinese patent application No. 202411000986.2 filed on Jul. 24, 2024, the entire contents of which are hereby incorporated by reference as a part of the present application.

### TECHNICAL FIELD

Embodiments of the present disclosure relate to computer application technologies, in particular to a method and an apparatus for effect processing, and a storage medium.

### BACKGROUND

With the development of various technologies, effect processing technologies in the image field become increasingly widespread. Generating a new image based on an existing image to present different image effects is one of the commonly used manners in effect processing.

In related technologies, the effect processing is often only supported for a single existing image, so that the content of the effect image generated is often monotonous relatively, which affects the presentation effect of the effect image. In addition, in effect processing scenes, provided interaction manners are relatively single, not flexible enough, lack interestingness, and affect the effect processing experience.

### SUMMARY

The present disclosure provides a method and an apparatus for effect processing, and a storage medium, as to enrich the presentation effect of effect images.

In a first aspect, an embodiment of the present disclosure provides a method for effect processing, the method comprises:
in response to an image setting operation, acquiring a plurality of first images which are provided, the plurality of first images comprising at least two content reference images and a posture reference image, and the posture reference image comprising a plurality of first objects;
in response to an effect triggering operation, generating an effect image according to the at least two content reference images and the posture reference image,
wherein the effect image comprises a plurality of effect objects, at least a portion of the object content in the plurality of effect objects is associated with at least a portion of the image content in the at least two content reference images, and posture information of each of the plurality of effect objects is associated with posture information of one of the plurality of first objects

In a second aspect, an embodiment of the present disclosure provides a device for effect processing, the device comprises:
an image acquisition module, configured to, in response to an image setting operation, acquire a plurality of first images which are provided, the plurality of first images comprising at least two content reference images and a posture reference image, and the at least one posture reference image comprising a plurality of first objects; and
an image generation module, configured to, in response to an effect triggering operation, generate an effect image according to the at least two content reference images and the posture reference image, the effect image comprising a plurality of effect objects, at least a portion of the object content in the plurality of effect objects being associated with at least a portion of the image content in the at least two content reference images; and posture information of the effect object being associated with posture information of the first object.

In a third aspect, an embodiment of the present disclosure provides an apparatus for effect processing, the apparatus comprises: one or more processors; and a non-transitory memory with instructions thereon, wherein the instructions upon execution by the one or more processors, cause the one or more processors to perform a method for effect processing, the method for effect processing comprises: in response to an image setting operation, acquiring a plurality of first images which are provided, the plurality of first images comprising at least two content reference images and a posture reference image, and the posture reference image comprising a plurality of first objects; in response to an effect triggering operation, generating a effect image according to the at least two content reference images and the posture reference image, wherein the effect image comprises a plurality of effect objects, at least a portion of the object content in the plurality of effect objects is associated with at least a portion of the image content in the at least two content reference images, and posture information of each of the plurality of effect objects is associated with posture information of one of the plurality of first objects.

In a fourth aspect, an embodiment of the present disclosure provides a non-transitory computer-readable storage medium, comprising computer executable instructions, wherein the computer executable instructions, upon running on a computer, cause the computer to perform a method for effect processing, the method for effect processing comprises: in response to an image setting operation, acquiring a plurality of first images which are provided, the plurality of first images comprising at least two content reference images and a posture reference image, and the posture reference image comprising a plurality of first objects; in response to an effect triggering operation, generating an effect image according to the at least two content reference images and the posture reference image, wherein the effect image comprises a plurality of effect objects, at least a portion of the object content in the plurality of effect objects is associated with at least a portion of the image content in the at least two content reference images, and posture information of each of the plurality of effect objects is associated with posture information of one of the plurality of first objects.

In a fifth aspect, an embodiment of the present disclosure provides a computer program product, and the computer program product comprises a computer program, and the method for effect processing as mentioned in any of embodiments of the present disclosure is implemented when the computer program is executed by a processor.

### BRIEF DESCRIPTION OF DRAWINGS

The above and other features, advantages, and aspects of the embodiments of the present disclosure will become more apparent in conjunction with the attached drawings and with reference to the specific embodiments below. Throughout the drawings, identical or similar reference number denotes identical or similar element. It should be understood that the drawings are schematic and that the members and elements are not necessarily drawn according to the scale.

FIG. 1 is a flow schematic diagram of a method for effect processing provided in an embodiment of the present disclosure;

FIG. 2 is a reference schematic diagram of a posture reference image provided in an embodiment of the present disclosure;

FIG. 3 is a flow schematic diagram of another method for effect processing provided in an embodiment of the present disclosure;

FIG. 4 is a reference schematic diagram of an object mask image provided in an embodiment of the present disclosure;

FIG. 5 is a flow schematic diagram of another method for effect processing provided in an embodiment of the present disclosure;

FIG. 6 is a reference schematic diagram of a posture mask image provided in an embodiment of the present disclosure;

FIG. 7 is a structure schematic diagram of a device for effect processing provided in an embodiment of the present disclosure; and

FIG. 8 is a structure schematic diagram of an electronic apparatus provided in an embodiment of the present disclosure.

### DETAILED DESCRIPTION

Embodiments of the present disclosure will be in detail described hereinafter in conjunction with the accompanying drawings. Although some embodiments of the present disclosure are shown in the accompanying drawings, it should be understood that the present disclosure may be implemented in various forms and should not be interpreted as limited to the embodiments set forth herein, but rather are provided for a more thorough and complete understanding of the present disclosure. It should be understood that the drawings and embodiments of the present disclosure are for illustrative purposes only and are not intended to limit the protection scope of the present disclosure.

It should be understood that the various steps described in the method embodiments of the present disclosure may be executed in different order and/or in parallel. In addition, method embodiments may include additional steps and/or omit the steps shown by the execution. The scope of the present disclosure is not limited in the respect.

The term “including” as used herein and its variations are open-ended including, i.e., “including but not limited to”. The term “based on” means “at least partially based on”. The term “one embodiment” means “at least one embodiment”; The term “another embodiment” means “at least one other embodiment”; The term “some embodiments” means “at least some embodiments”. Definitions of other terms are given in the description below.

It needs to be noted that “first”, “second” and other concepts mentioned in the present disclosure are used only to distinguish different devices, modules or units and are not used to define the order or interdependent relation of the functions performed by these devices, modules or units.

It needs to be noted that modifiers of “a/an” and “a plurality of” mentioned in the present disclosure are schematic rather than restrictive, and it should be understood by those skilled in the art that they are understood as “one or a plurality of” unless otherwise defined in the context.

The names of messages or information exchanged between a plurality of devices in embodiments of the present disclosure are only for descriptive purposes and are not intended to limit the scope of these messages or information.

It may be understood that before technical solutions disclosed in each embodiment of the present disclosure are used, users should be informed of the types, usage scopes, and usage scenarios and the like of personal information involved in the present disclosure by appropriate means in accordance with relevant laws and regulations, and user authorization should be acquired.

For example, in response to receiving a user's active request, prompt information is sent to the user, and the user is explicitly prompted that an operation being requested to execute by him/her will require acquiring and using the user's personal information. Thus, the user may autonomously select whether to provide the personal information to software or hardware such as an electronic apparatus, an application program, a server, or a storage medium that executes the operations of the technical solutions of the present disclosure according to the prompt information.

As an optional but non-restrictive implementation mode, in response to receiving the user's active request, the way to send the prompt information to the user may be, for example, in the form of a pop-up window, and the prompt information may be presented in the pop-up window in the form of a text. In addition, the pop-up window may also carry a selection control for the user to select whether to “agree” or “disagree” to provide the personal information to the electronic apparatus.

It may be understood that the above informing and acquiring the user authorization processes are only schematic and do not limit the implementation modes of the present disclosure. Other modes that meet the relevant laws and regulations may also be applied to the implementation modes of the present disclosure.

It may be understood that data involved in the present technical solution (including but not limited to the data itself, data acquisition or use) should comply with the requirements of corresponding laws and regulations and relevant provisions.

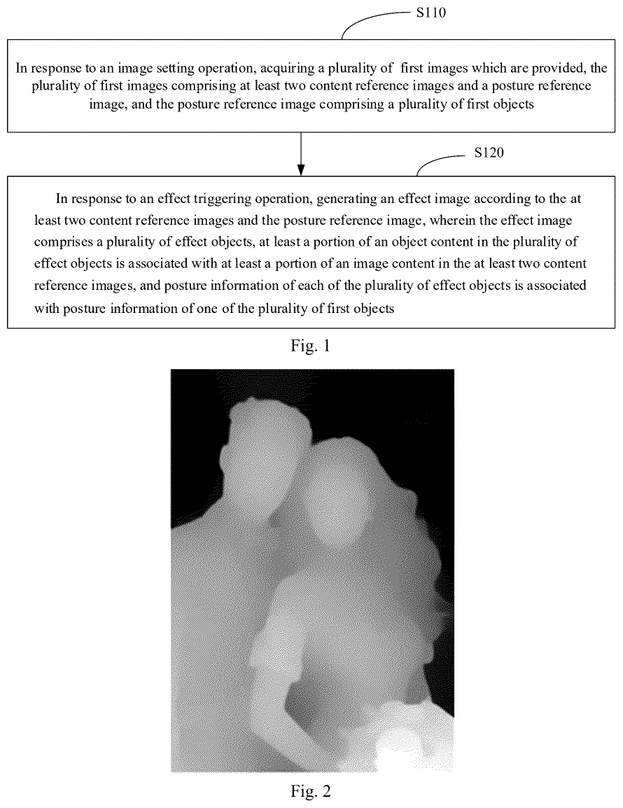

FIG. 1 is a flow schematic diagram of a method for effect processing provided in an embodiment of the present disclosure, the embodiment of the present disclosure is applicable to presenting a plurality of objects in the same image in different postures or the same posture. The method may be executed by a device for effect processing, and the device may be implemented in software and/or hardware form. Optionally, it is implemented by an electronic apparatus, and the electronic apparatus may be a mobile terminal, a personal computer (PC), or a server or the like.

As shown in FIG. 1, the method for effect processing of the present embodiment may specifically include:

S110, in response to an image setting operation, acquiring a plurality of first images which are provided; herein, the plurality of first images includes at least two content reference images and a posture reference image; and the posture reference image includes a plurality of first objects.

Herein, the image setting operation may be understood as an operation which sets a first image for generating an effect image. The image setting operation may include but not limited to an image shooting operation and/or an image uploading operation and the like. The first image may be understood as an image used to indicate the presentation effect of the effect image. The first object may be understood as an object that provides reference for posture information of the effect object. In the embodiment of the present disclosure, the first object may be a preset type of an object. Generally, a plurality of first objects in the posture reference image are the same preset type of the objects. The content reference image may be understood as an image used to generate at least a portion of the object content of the effect object in the effect image. The posture reference image may be understood as an image used to guide the presentation of posture information of a plurality of effect objects included in the effect image. The posture reference image may be an image with color information or an image represented in the form of a binary image, as shown in FIG. 2.

In the embodiment of the present disclosure, in response to an image setting operation, acquiring a plurality of first images which are provided may include: in response to the image setting operation, acquiring the set posture reference image; and in response to the image setting operation, acquiring the at least two set content reference images.

In response to the image setting operation, the acquiring the set posture reference image may include: displaying at least one candidate posture image; in response to a first image selection operation input for the candidate posture image, selecting at least one posture reference image from the preset candidate posture images; herein, the image selection operation may include operations of selecting and deselecting. The candidate posture image may be a preset posture template image or a set image in a first image repository.

In the embodiment of the present disclosure, in response to the image setting operation, the acquiring the set posture reference image may include: in response to a first image editing operation, generating at least one posture reference image according to a preset posture requirement; herein, the image editing operation may include an operation for drawing an image according to the preset posture requirement, or an operation for inputting the preset posture requirement to an image generator, so that the image generator generates at least one posture reference image. The image generator is a tool used to generate an object posture that meets the preset posture requirement.

In the embodiment of the present disclosure, in response to the image setting operation, the acquiring the set posture reference image may include: in response to a first image screenshot operation, capturing at least one posture reference image from a specified page; and the specified page may be the current operation page or other pages to which is jumped.

In the embodiment of the present disclosure, in response to the image setting operation, the acquiring the at least two set content reference images may include: displaying at least two candidate content images; in response to a second image selection operation input for the content reference image, selecting at least two candidate content images from preset candidate content images; herein, the image selection operation may include operations of selecting and deselecting. The candidate content image may be a preset image in a second image repository.

In the embodiment of the present disclosure, in response to the image setting operation, the acquiring the at least two set content reference images may include: shooting at least a preset number of reference content images; in response to a shooting operation input for the content reference image, selecting at least two content reference images from at least the preset number of the reference content images. Herein, the minimum number of the preset number is determined according to the number of the content reference images required.

In the embodiment of the present disclosure, in response to the image setting operation, the acquiring the at least two set content reference images may include: in response to a second image screenshot operation, capturing at least two content reference images from a specified page. The specified page may be the current operation page or other pages to which is jumped.

S120, in response to an effect triggering operation, generating an effect image according to the content reference images and the posture reference image; herein the effect image includes a plurality of effect objects; at least a portion of the object content in the effect objects is associated with at least a portion of the image content in the content reference images; and posture information of the effect object is associated with posture information of the first object.

Herein, the effect triggering operation may be understood as an operation which begins to generate the effect image after being triggered. The effect image includes a plurality of effect objects that may be in a one-to-one corresponding relationship with a plurality of first objects in the posture reference image. Optionally, at least a portion of the object content in the effect object may be identical or satisfy a first similarity with at least a portion of the image content in the content reference image, or at least a portion of the object content in the effect object may be generated by at least a portion of the image content in the content reference image. The posture information of the effect object may be the same as or satisfy a second similarity with the posture information of the first object.

Further, specifically, feature analysis may be performed on the content reference image, to determine a target content feature respectively corresponding to each first object, and the posture reference image may be analyzed, to determine a target posture feature corresponding to each first object; further, the target content feature and the target posture feature corresponding to each first object are fused, to generate the effect image that achieves a preset effect.

Herein, the target content feature is used to describe information features of fillable content of a corresponding specific position of the first object, such as contour information, texture information, and color information. For a facial feature, it may include at least one of facial contour, skin color feature, texture feature, facial organs feature, and facial state feature. The target posture feature may be understood as parameter information of describing the presented corresponding posture of the first object, which may include at least one of position information, orientation information, center of gravity information, and posture information of the local position and the like of the first object.

As an optional technical solution of the embodiment of the present disclosure, before in response to an effect triggering operation, it further includes: in response to a style setting operation, determining an image style corresponding to the effect image, to generate the effect image according to the content reference image, the posture reference image, and the image style.

Herein, the style setting operation may be understood as an operation for selecting an image style. The image style may be understood as unique visual features and representation form presented by the image. For example, the image style may include at least one of realistic style, abstract style, cartoon style, hand drawing style, retro style, concise style, and magical style and the like. The realistic style strives to depict objects, scenes, and characters in the real world as realistically as possible, and emphasizes the realistic restoring of details and light and shadow. The abstract style emphasizes a combination of forms and colors by simplifying, transforming, or recombining graphic elements, as to convey emotions or concepts rather than concrete objects. The cartoon style usually has simple lines, vivid colors, and exaggerated features, and the image is full of child interest. The hand drawing style imitates the effect of hand drawing, such as pencil sketching, watercolor, or oil painting, with a texture of brushstrokes and grains. The retro style imitates the image characteristics of a certain specific period in the past, for example, at least one of color tones, compositions, and decorative elements, and a nostalgic feeling is given to people. The concise style is to express the subject by using concise, clear form and limited elements, and avoid excessive details and decorations. The magical style often contains fantastical elements, bizarre colors, and supernatural scenes or characters.

The embodiment of the present disclosure provides a rich and diverse selection of the image styles that may adapt to different scenes and needs, so that the effect image generated according to the content reference image, the posture reference image, and the image style fully meets the differentiated needs of the users.

As another optional technical solution of the embodiment of the present disclosure, a specified image style may be preset, and then the effect image with the preset image style may be generated according to the content reference image and the posture reference image, to ensure that the effect images generated present the unified image style.

The technical solutions of the embodiments of the present disclosure acquire a plurality of set first images in response to an image setting operation, provide an interactive entrance for multiple-images setting and guarantee the richness of information that may be used when an effect image is generated. Since the a plurality of first images include at least two content reference images and at least one posture reference image, and the posture reference image includes a plurality of first objects, the plurality of content reference images provide the rich content basis for at least a portion of the object content in the effect object, and posture information of the first object in the posture reference image provides the basis for posture information of the effect object; furthermore, in response to an effect triggering operation, the effect image is accurately generated according to the content reference image and the posture reference image, thereby at least a portion of the image content in a plurality of content reference images is presented in the same image and the effect object in the effect image presents the desired posture. This solves a technical problem in related art that the content of the effect image generated is relatively monotonous and the interaction mode is relatively simple, and the display effect of the effect image is enriched.

FIG. 3 is a flow schematic diagram of another method for effect processing provided in an embodiment of the present disclosure. The technical solution of the present embodiment further elaborates the generation mode of the effect image based on the above embodiment. Optionally, the generating an effect image according to the content reference image and the posture reference image comprises: determining a first corresponding relationship between the content reference image and the first object in the posture reference image, and generating the effect image according to the content reference image, the posture reference image, and the first corresponding relationship. The specific implementation mode may refer to the description of the embodiment. Herein, technical features that are the same or similar to the previous embodiment are not repeatedly described here.

As shown in FIG. 3, the method of the embodiment may specifically include:

S210, in response to an image setting operation, acquiring a plurality of set first images, herein, the plurality of first images include at least two content reference images and at least one posture reference image; and the posture reference image includes a plurality of first objects.

S220, in response to an effect triggering operation, determining a first corresponding relationship between the content reference image and the first object in the posture reference image.

Specifically, the first corresponding relationship may be understood as which first object in the posture reference image corresponds to the target image content in the content reference image, and is used to describe the association relationship between the content reference image and the first object in the posture reference image. The posture reference image in FIG. 2 is taken as an example, the posture reference image includes two first objects, and the first corresponding relationship may indicate which content reference image to combine with which of the two first objects to generate the effect object. More specifically, the target image content in the content reference image may be facial information, and the first object is a portrait. The first corresponding relationship may be used to indicate which facial information in the content reference image is combined with which portrait, to generate the effect object.

As an optional but non-limiting implementation mode, the determining the first corresponding relationship between the content reference image and the first object in the posture reference image includes: in response to a relationship setting operation input for at least one content reference image and/or posture reference image, determining the first corresponding relationship between the content reference image and the first object in the posture reference image.

Herein, the relationship setting operation may be understood as an operation for establishing the relationship between the content reference image and the first object in the posture reference image. For example, it may be at least one of operations such as selecting, dragging, and labeling at least one content reference image and/or posture reference image in an operation interface. The dragging operation may be to randomly drag the content reference image onto the first object in the posture reference image in the operation interface. The continuous selecting operation may be to continuously click on the content reference image and the first object in the posture reference image in the operation interface. The labeling operation may be an operation performed on the operation interface by clicking on the posture reference image in a first preset order to add labels for distinguishing the first objects, or an operation by clicking on the content reference image and the posture reference image to add corresponding labels, or an operation by clicking on the posture reference image in the first preset order and arranging the content reference image in a second preset order, or the like.

In the embodiment of the present disclosure, in response to the relationship setting operation input for at least one content reference image and/or posture reference image, the determining the first corresponding relationship between the content reference image and the first object in the posture reference image may include: in response to a dragging operation for dragging at least one content reference image to the posture reference image, determining the first corresponding relationship between the content reference image and the first object in the posture reference image by using the releasing position of the content reference image in the posture reference image and the display position of the first object in the posture reference image. For example, the first corresponding relationship is established between the first object closest to the releasing position of the content reference image and the content reference image.

In the embodiment of the present disclosure, in response to the relationship setting operation input for at least one content reference image and/or posture reference image, the determining the first corresponding relationship between the content reference image and the first object in the posture reference image may include: in response to a continuous selection operation input for a plurality of first objects of the posture reference image, determining an arrangement order of the a plurality of first objects, and determining the first corresponding relationship between the content reference image and the first object in the posture reference image according to the arrangement order of a plurality of content reference images and the arrangement order of the a plurality of first objects.

In the embodiment of the present disclosure, in response to the relationship setting operation input for at least one content reference image and/or posture reference image, the determining the first corresponding relationship between the content reference image and the first object in the posture reference image may include: in response to an alternate clicking operation input for at least one content reference image and the first object in the posture reference image, determining the first corresponding relationship between the content reference image and the first object in the posture reference image based on the alternate clicking operation. For example, the first corresponding relationship may be established between the content reference image and the first object in the posture reference image which are in a selected state and whose clicking times are adjacent to each other.

The technical solution of the embodiment determines the first corresponding relationship between the content reference image and the first object in the posture reference image in response to the relationship setting operation input for at least one content reference image and/or posture reference image. The first corresponding relationship may be accurately established in the operation mode of the relationship setting operation, and according to the first corresponding relationship, it can be accurately determined which first object in the posture reference image the content reference image acts on, thereby the precise conversion of the first object into the effect object by effect processing is achieved. If the first object needs to be changed, according to the first corresponding relationship, it can be determined which first object needs to be changed, as long as it acts on the first object that needs to be changed, which greatly shortens the time for effect processing, and also enhances the effect of image presentation after the effect processing.

S230, generating the effect image according to the content reference image, the posture reference image, and the first corresponding relationship.

Specifically, the content reference image is proved to be in a one-to-one corresponding relationship with the first object in the posture reference image according to the first corresponding relationship, and the content reference image respectively acts on the first object corresponding to the content reference image, to generate the effect image.

As an optional technical solution of the embodiment of the present disclosure, the generating the effect image according to the content reference image, the posture reference image, and the first corresponding relationship may include the following Steps A1-A2:

Step A1, determining an object mask image corresponding to each first object in the posture reference image respectively.

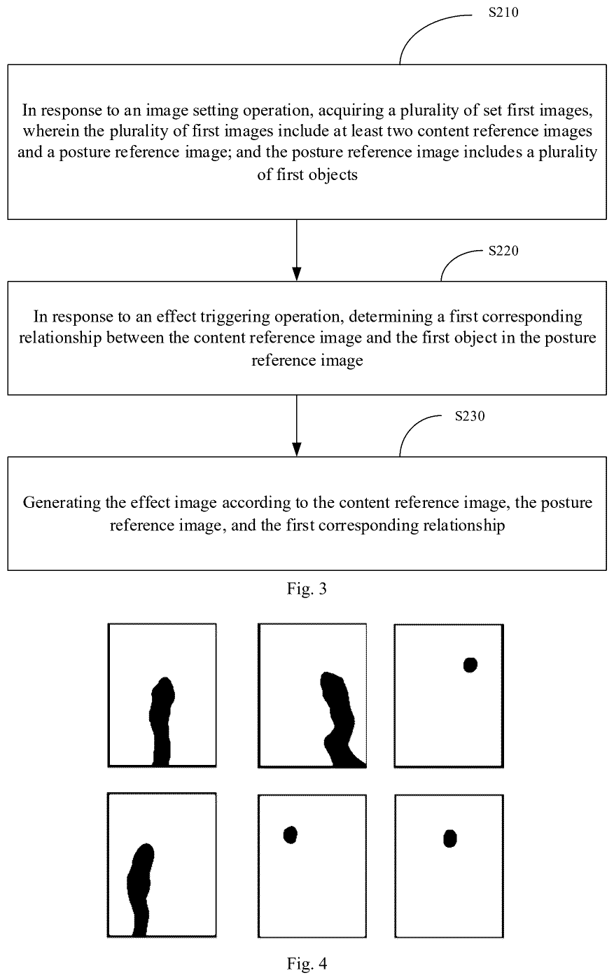

Herein, the image region corresponding to the first object has the same display position in the object mask image and the posture reference image. The object mask image is a binary image that displays one first object, and the object mask image may be an image that displays the entire first object and an image that specifies the specific position and size of the first object when displayed, as shown in FIG. 4, the object mask images respectively corresponding to a plurality of first objects may be extracted from one posture reference image. The size of each object mask image may be the same as the size of the posture reference image, or the size of the effect image to be generated.

When the posture reference image is a preset posture template image, a mask image library storing the object mask image may be established in advance, and a target association relationship between the posture template image, the first object in the posture template image, and the object mask image may be established, so that the object mask image corresponding to each first object in the posture reference image may be called from the mask image library based on the target association relationship, as to determine the object mask image corresponding to each first object in the posture reference image respectively.

In the embodiment of the present disclosure, an Attention Mask mode may also be used to determine the object mask image corresponding to each first object in the posture reference image, namely if the object mask image corresponding to a reference object is determined, the attention mask needs to be used to mask other first objects except for the reference object in the posture reference image, and only the reference object is displayed, thereby the object mask image corresponding to the reference object is acquired. The reference object is an object selected from the first objects.

Step A2, determining a second corresponding relationship between the content reference image and the object mask image according to the first corresponding relationship, and generating the effect image according to a plurality of content reference images, a plurality of object mask images, and the second corresponding relationship.

Herein, the second corresponding relationship may be used to describe a one-to-one corresponding relationship between the content reference image and the object mask image, as to indicate which content reference image each object mask image is related with.

Specifically, the first corresponding relationship may indicate which first object in the posture reference image each content reference image respectively corresponds to, while the object mask image may correspond to one first object in the posture reference image. By intermediate connection of the first object, the second corresponding relationship between the content reference image and the object mask image may be determined. Further, according to the indication of the second corresponding relationship, each content reference image is fused respectively with the object mask image corresponding to each content reference image, to generate the effect image.

In the technical solution of the embodiment, the object mask image corresponding to each first object in the posture reference image is respectively determined, in order to effectively distinguish the object mask image corresponding to each first object, as to facilitate to subsequently perform the effect processing respectively on each first object. Further, according to the first corresponding relationship, the second corresponding relationship between the content reference image and the object mask image is determined, and the establishment of the second corresponding relationship may accurately determine which object mask image each content reference image should act on, the generation of the effect image with the poor effect is avoided due to incorrect action, as to generate the high-quality effect image according to a plurality of content reference images, a plurality of object mask images, and the second corresponding relationship.

As an optional technical solution of the embodiment of the present disclosure, the generating the effect image according to the content reference image, the object mask image, and the second corresponding relationship includes: inputting the content reference image and the object mask image to an effect generation model according to the second corresponding relationship, to obtain the effect image; herein, the effect generation model is obtained by training a diffusion model through sample content patterns and sample mask images.

Herein, the diffusion model may continuously mix the input data (such as the image) with Gaussian noise, and after a plurality of times of noise addition operations, the data may become pure noise data that conforms to standard normal distribution.

Specifically, each content reference image and the object mask image corresponding to the content reference image are determined according to the second corresponding relationship, and each content reference image and the object mask image corresponding to the content reference image are input to the effect generation model in a preset format, to obtain the effect image.

Herein, the preset format may be a way to describe the input of each content reference image and the object mask image corresponding to the content reference image to the effect generation model, which may be used to indicate that the effect generation model combines and processes each content reference image and the object mask image corresponding to the content reference image. The preset format may include but not limited to a splicing format, a labeling format, and a sorting format.

The splicing format may be a format that splices the content reference image and the object mask image corresponding to the content reference image into a target image group, which is used to indicate the effect generation model to perform effect processing on images in the target image group respectively to generate the effect image.

The labeling format may be to set the content reference image and the object mask image corresponding to the content reference image to have the same label, the labels of each content reference image are different, and the labels of each object mask image are different. The labeling format is used to indicate the effect generation model to perform the effect processing on the image combination with the same label, to generate the effect image. Optionally, the labels of the content reference image and the object mask image having the second corresponding relationship may be the same.

The sorting format may be a format of arranging one content reference image and the object mask image corresponding to the one content reference image, namely according to a mode that the first image is the content reference image and the second image is the object mask image corresponding to the content reference image, it is input to the effect generation model, as to indicate the effect generation model to perform the effect processing on two consecutive images being different types and being the same first object, to obtain the effect image.

The technical solution of the embodiment inputs the content reference image and the object mask image to the effect generation model according to the second corresponding relationship. Since the input data is the content reference image and the object mask image corresponding to the first object, it is guaranteed that the effect generation model may accurately perform the effect processing on the content reference image and the object mask image corresponding to each target, and it is guaranteed that each effect object in the output effect image may be displayed with high quality in a specified posture.

The technical solution of the embodiment of the present disclosure determines the first corresponding relationship between the content reference image and the first object in the posture reference image in response to the effect triggering operation. The determination of the first corresponding relationship may indicate which of a plurality of first objects each content reference image belongs to, the content reference image is avoided from mistakenly acting on the first object in the posture reference image, so that the chaotic display of the generated effect image which is caused is avoided. Namely according to the content reference image, the posture reference image, and the first corresponding relationship, the presentation position of the target image content of the content reference image in the effect image and the posture of the effect object may be effectively guided, to achieve the high-quality effect of respectively presenting a plurality of effect objects in rich postures in the same effect image.

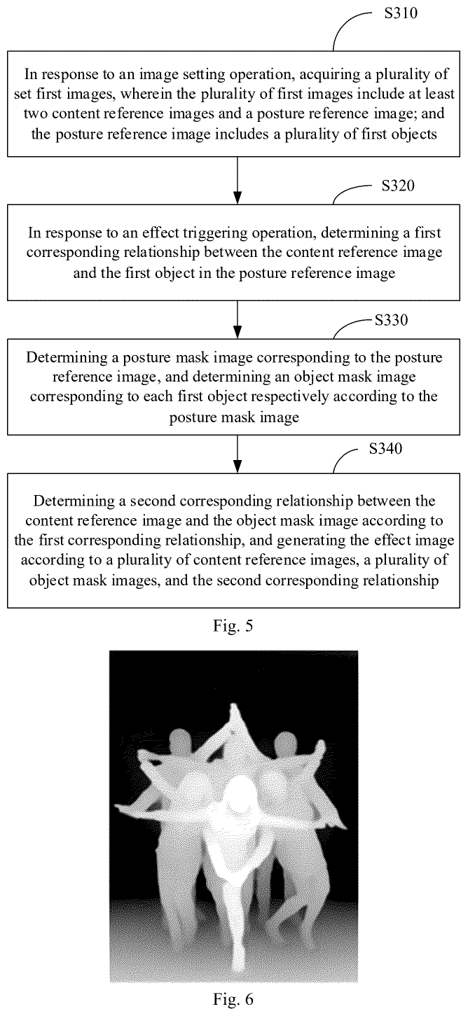

FIG. 5 is a flow schematic diagram of another method for effect processing provided in an embodiment of the present disclosure. The technical solution of the embodiment, based on the above embodiment, further elaborates “determining the object mask image corresponding to each first object in the posture reference image respectively”. Optionally, the determining the object mask image corresponding to each first object in the posture reference image respectively includes: determining the posture mask image corresponding to the posture reference image, and determining the object mask image corresponding to each first object respectively according to the posture mask image. The specific implementation mode may refer to the description of the embodiment. Herein, technical features that are the same or similar to the previous embodiment are not repeatedly described here.

As shown in FIG. 5, the method for effect processing of the embodiment may specifically include:

S310, in response to an image setting operation, acquiring a plurality of set first images; herein, the plurality of first images include at least two content reference images and at least one posture reference image; and the posture reference image includes a plurality of first objects.

S320, in response to an effect triggering operation, determining a first corresponding relationship between the content reference image and the first object in the posture reference image.

S330, determining a posture mask image corresponding to the posture reference image, and determining an object mask image corresponding to each first object respectively according to the posture mask image.

Herein, the image region corresponding to the first object has the same display position in the object mask image and the posture reference image. The posture mask image may be a binary image that describes the posture information of all first objects and the mutual association information between postures, and the posture mask image is an image that is obtained by performing the binary progress on the posture reference image and contains all first objects, as shown in FIG. 6.

Further, the Attention Mask mode may be used to determine the object mask image corresponding to each first object in the posture mask image.

As an optional but non-limiting implementation mode, the determining the object mask image corresponding to each first object respectively according to the posture mask image may include the following Steps B1-B2:

Step B1, performing image segmenting on the posture mask image, to obtain a local mask image corresponding to each first object respectively.

Herein, the local mask image may be understood as a local image containing the first object and segmented from the posture mask image.

Optionally, the image segmenting may be performed on the posture mask image by identifying the first object in the posture mask image, annotating an outer contour of the first object according to an identification result, and then cutting the image region containing the first object from the posture mask image as the local mask image corresponding to the first object according to the outer contour of the first object.

Step B2, for each local mask image, according to the display position of the first object corresponding to the local mask image in the posture mask image and the image size of the posture mask image, performing image filling on the local mask image, to obtain the object mask image corresponding to the first object.

Specifically, in order to ensure that the position and size of the object mask image present the expected effects, the segmented local mask image may be filled. Specifically, the display position and image size of the first object corresponding to the local mask image in the posture mask image may be determined, and then the local mask image may be filled according to the display position and image size, so that the object mask image obtained can match with the first object in the posture mask image.

In an optional implementation mode, the first object in the local mask image may be aligned with the first object in the posture mask image according to the display position of the first object corresponding to the local mask image in the posture mask image. Then, the local mask image may be filled according to the image size of the posture mask image to obtain a mask image having the same image size as the posture mask image, which serves as the object mask image of the first object.

The technical solution of the embodiment, by performing the image segmenting on the posture mask image, acquires the local mask image corresponding to each first object respectively, and ensures that the local mask image reflects the image of the first object. Furthermore, for each local mask image, according to the display position of the first object corresponding to the local mask image in the posture mask image and the image size of the posture mask image, the local mask image is performed the image filling, to obtain the object mask image corresponding to the first object. The setting of the display position and image size may ensure that the object mask image corresponding to the target may be accurately obtained on the basis of the local mask image, and the poor quality of the effect image obtained by subsequent effect processing is avoided due to position and size errors.

S340, determining a second corresponding relationship between the content reference image and the object mask image according to the first corresponding relationship, and generating the effect image according to a plurality of content reference images, a plurality of object mask images, and the second corresponding relationship.

The technical solution of the embodiment of the present disclosure determines the posture mask image corresponding to the posture reference image, and determines the object mask image corresponding to each first object respectively according to the posture mask image. Namely, the object mask image corresponding to each first object is obtained from the posture mask image, the accuracy of the object mask image of the first object is ensured, and it is not an object mask image representing other object. Therefore, according to the first corresponding relationship, the second corresponding relationship between the content reference image and the object mask image is determined. The establishment of the second corresponding relationship may accurately determine which object mask image each content reference image should act on, the generated effect image with the poor effect is avoided due to the mistaken action, so that the target image content of the content reference image is accurately presented at the desired position in the effect image according to the plurality of content reference images, the plurality of object mask images, and the second corresponding relationship.

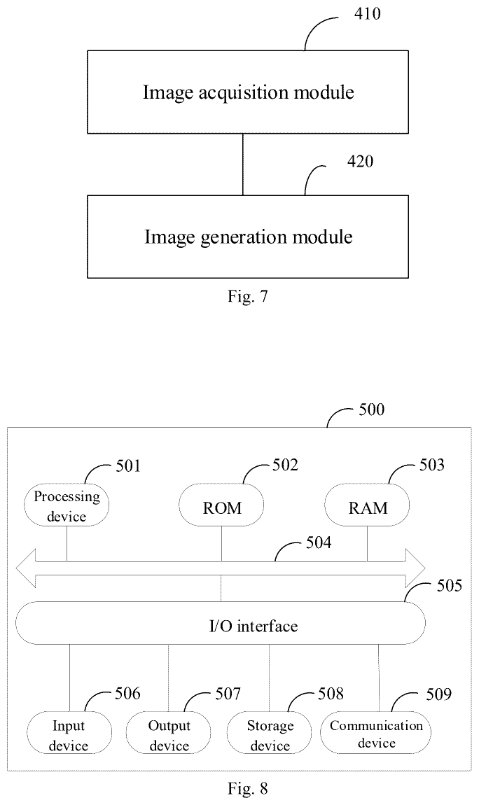

FIG. 7 is a structure schematic diagram of a device for effect processing provided in an embodiment of the present disclosure, the embodiment of the present disclosure is applicable to presenting a plurality of objects in the same image in different postures or the same posture, and the device for effect processing may be implemented in software and/or hardware form. Optionally, it is implemented by an electronic apparatus, and the electronic apparatus may be a mobile terminal, a PC, or a server or the like.

As shown in FIG. 7, the device for effect processing of the present disclosure includes: an image acquisition module 410 and an image generation module 420. Herein the image acquisition module 410 is used to, in response to an image setting operation, acquire a plurality of set first images; herein, the plurality of first images includes at least two content reference images and at least one posture reference image; and the posture reference image includes a plurality of first objects. The image generation module 420 is used to, in response to an effect triggering operation, generate an effect image according to the content reference image and the posture reference image; herein the effect image includes a plurality of effect objects; at least a part of the object content in the effect object is associated with at least a part of the image content in the content reference image; and posture information of the effect object is associated with posture information of the first object.

On the basis of the above optional technical solutions, optionally the image generation module includes a first image generation unit, and the first image generation unit is used to: determine a first corresponding relationship between the content reference image and the first object in the posture reference image, and generate the effect image according to the content reference image, the posture reference image, and the first corresponding relationship.

On the basis of the above optional technical solutions, optionally, the first image generation unit includes a corresponding relationship determining unit, and the corresponding relationship determining unit is used to: in response to a relationship setting operation input for at least one content reference image and/or posture reference image, determine the first corresponding relationship between the content reference image and the first object in the posture reference image.

On the basis of the above optional technical solutions, optionally the first image generation unit includes a mask image determining unit and an effect image generating unit. The mask image determining unit is used to: determine an object mask image corresponding to each first object in the posture reference image respectively; herein, the image region corresponding to the first object has the same display position in the object mask image and the posture reference image; and the effect image generating unit is used to: determine a second corresponding relationship between the content reference image and the object mask image according to the first corresponding relationship, and generate the effect image according to a plurality of content reference images, a plurality of object mask images, and the second corresponding relationship.

On the basis of the above optional technical solutions, optionally the effect image generating unit is used to: input the content reference image and the object mask image to an effect generation model according to the second corresponding relationship, to obtain the effect image; herein, the effect generation model is obtained by training a diffusion model through sample content patterns and sample mask images.

On the basis of the above optional technical solutions, optionally the mask image determining unit includes an object mask image determining unit, and the object mask image determining unit is used to: determine a posture mask image corresponding to the posture reference image, and determine an object mask image corresponding to each first object according to the posture mask image.

On the basis of the above optional technical solutions, optionally the object mask image determining unit is used to: perform image segmenting on the posture mask image, to obtain a local mask image corresponding to each first object respectively; and for each local mask image, according to the display position of the first object corresponding to the local mask image in the posture mask image and the image size in the posture mask image, fill the local mask image, to obtain the object mask image corresponding to the first object.

On the basis of the above optional technical solutions, optionally the image generation module further includes an image style determining unit, the image style determining unit is used to: in response to a style setting operation, determine an image style corresponding to the effect image; and the image generation module is also used to: generate the effect image according to the content reference image, the posture reference image, and the image style.

The device for effect processing provided in the embodiment of the present disclosure may execute the method for effect processing provided in any embodiment of the present disclosure, and has functional modules and beneficial effects corresponding to the executing method.

It is worth noting that the various units and modules included in the above device are only divided according to functional logic, but are not limited to the above division, as long as it may achieve the corresponding functions; in addition, the specific name of each functional unit is only for the purpose of distinguishing it from each other and is not intended to limit the protection scope of the embodiments of the present disclosure.

FIG. 8 is a structure schematic diagram of an apparatus for effect processing provided in an embodiment of the present disclosure. Referring to FIG. 8 below, it shows the structure schematic diagram of the apparatus for effect processing (such as a terminal apparatus or a server in FIG. 8) 500 suitable for implementing the embodiment of the present disclosure. The terminal apparatus in the embodiment of the present disclosure may include but not limited to a mobile terminal such as a mobile phone, a notebook computer, a digital broadcasting receiver, a personal digital assistant (PDA), a portable android device (PAD), a portable multimedia player (PMP), and a vehicle terminal (such as a vehicle navigation terminal), and a fixed terminal such as a digital television (TV) and a desktop computer. The apparatus for effect processing shown in FIG. 8 is only an example and should not impose any limitations on the functions and usage scopes of the embodiments of the present disclosure.

As shown in FIG. 8, the apparatus for effect processing 500 may include a processing device (such as a central processing unit, and a graphics processor) 501, and it may execute various appropriate actions and processes according to a program stored in a read-only memory (ROM) 502 or a program loaded from a storage device 508 to a random access memory (RAM) 503. In RAM 503, various programs and data required for operations of the apparatus for effect processing 500 are also stored. The processing device 501, ROM 502, and RAM 503 are connected to each other by a bus 504. An input/output (I/O) interface 505 is also connected to the bus 504.

Typically, the following devices may be connected to the I/O interface 505: an input device 506 such as a touch screen, a touchpad, a keyboard, a mouse, a camera, a microphone, an accelerometer, and a gyroscope; an output device 507 such as a liquid crystal display (LCD), a loudspeaker, and a vibrator; a storage device 508 such as a magnetic tape, and a hard disk drive; and a communication device 509. The communication device 509 may allow the apparatus for effect processing 500 to wireless-communicate or wire-communicate with other apparatuses so as to exchange data. Although FIG. 8 shows the apparatus for effect processing 500 with various devices, it should be understood that it is not required to implement or possess all the devices shown. Alternatively, it may implement or possess the more or less devices.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such embodiment, the computer program may be downloaded and installed from the network by the communication device 509, or installed from the storage device 508, or installed from ROM 502. When the computer program is executed by the processing device 501, the above functions in the method in the embodiments of the present disclosure are executed.

The names of the messages or information exchanged between a plurality of devices in the implementation modes of the present disclosure are only for the descriptive purposes and are not intended to limit the scopes of these messages or information.

The apparatus for effect processing provided in the embodiment of the present disclosure belongs to the same inventive concept as the method for effect processing provided in the above embodiment. Technical details that are not described in detail in this embodiment may be found in the above embodiments, and this embodiment has the same beneficial effects as the above embodiments.

An embodiment of the present disclosure provides a computer storage medium in which a computer program is stored, and when the program is executed by a processor, the method for effect processing provided in the above embodiment is implemented.

It should be noted that the above computer-readable medium in the present disclosure may be a computer-readable signal medium, a computer-readable storage medium, or any combinations of the two. The computer-readable storage medium may be but not limited to, for example, a system, a device or a member of electricity, magnetism, light, electromagnetism, infrared, or semiconductor, or any combinations of the above. More specific examples of the computer-readable storage medium may include but not limited to: an electric connector with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage member, a magnetic storage member or any suitable combinations of the above. In the present disclosure, the computer-readable storage medium may be any visible medium that contains or stores a program, and the program may be used by an instruction executive system, device or member, or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, device or member or in combination with it. The program code contained in the computer-readable medium may be transmitted by using any suitable medium, including but not limited to: a wire, an optical cable, a radio frequency (RF) or the like, or any suitable combinations of the above.

In some implementation modes, a client and a server may be communicated by using any currently known or future-developed network protocols such as a HyperText Transfer Protocol (HTTP), and may interconnect with any form or medium of digital data communication (such as a communication network). Examples of the communication network include a local area network (“LAN”), a wide area network (“WAN”), an internet work (such as the Internet), and an end-to-end network (such as an ad hoc end-to-end network), as well as any currently known or future-developed networks.

The above computer-readable medium may be contained in the above apparatus for effect processing; and it may also exist separately without being assembled into the apparatus for effect processing.

The above computer-readable medium carries one or more programs, and when the above one or more programs are executed by the electronic apparatus, the electronic apparatus: in response to an image setting operation, acquires a plurality of first images which are provided; herein, the plurality of first images including at least two content reference images and at least one posture reference image; and the posture reference image including a plurality of first objects; in response to an effect triggering operation, generates an effect image according to the content reference image and the posture reference image; herein the effect image including a plurality of effect objects; at least a portion of the object content in the effect objects being associated with at least a portion of the image content in the content reference images; and posture information of the effect object being associated with posture information of the first object.

The computer program code for executing the operation of the present disclosure may be written in one or more programming languages or combinations thereof, the above programming language includes but not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including LAN or WAN, or may be connected to an external computer (such as connected by using an internet service provider through the Internet).

The flow diagrams and the block diagrams in the drawings show possibly achieved system architectures, functions, and operations of systems, methods, and computer program products according to various embodiments of the present disclosure. At this point, each box in the flow diagram or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, which depends on the functions involved. It should also be noted that each box in the block diagram and/or the flow diagram, as well as combinations of the boxes in the block diagram and/or the flow diagram, may be achieved by using a dedicated hardware-based system that performs the specified function or operation, or may be achieved by using combinations of dedicated hardware and computer instructions.

The involved units described in the embodiments of the present disclosure may be achieved by a mode of software, or may be achieved by a mode of hardware. Herein, the name of the unit does not constitute a limitation on the unit itself in a certain situation. For example, the first acquiring unit may be also described as “a unit acquiring at least two internet protocol addresses”.

The functions described above in the specification may be at least partially executed by one or more hardware logic components. For example, non-restrictive exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a visible medium, and it may contain or store a program for use by or in combination with an instruction executive system, device, or apparatus. The machine-readable medium may be a machine-readable signal medium or a machine-readable storage medium. The machine-readable medium may include but not limited to an electronic, magnetic, optical, electromagnetic, infrared, or semiconductor system, device, or apparatus, or any suitable combinations of the above. More specific examples of the machine-readable storage medium may include an electric connector based on one or more wires, a portable computer disk, a hard disk, RAM, ROM, an erasable programmable read-only memory (EPROM or flash memory), an optical fiber, CD-ROM, an optical storage device, a magnetic storage device, or any suitable combinations of the above.

According to one or more embodiments of the present disclosure, [example 1] provides a method for effect processing, the method for effect processing comprises: in response to an image setting operation, acquiring a plurality of first images which are provided, the plurality of first images comprising at least two content reference images and at least one posture reference image, and each of the at least one posture reference image comprising a plurality of first objects; in response to an effect triggering operation, generating an effect image according to the at least two content reference images and the posture reference image, wherein the effect image comprises a plurality of effect objects, at least a portion of the object content in the plurality of effect objects is associated with at least a portion of the image content in the at least two content reference images, and posture information of each of the plurality of effect objects is associated with posture information of one of the plurality of first objects.

According to one or more embodiments of the present disclosure, [example 2] provides the method of the example 1, and further comprises: optionally, the generating an effect image according to the at least two content reference images and the posture reference image, comprising determining a first corresponding relationship between the at least two content reference images and the plurality of first objects in the posture reference image, and generating the effect image according to the at least two content reference images, the posture reference image, and the first corresponding relationship.

According to one or more embodiments of the present disclosure, [example 3] provides the method of the example 1, and further comprises: optionally, the determining the first corresponding relationship between the at least two content reference images and the plurality of first objects in the posture reference image, comprising: in response to a relationship setting operation being input for at least one of the at least two content reference images and/or the posture reference image, determining the first corresponding relationship between the at least two content reference images and the plurality of first objects in the posture reference image.

According to one or more embodiments of the present disclosure, [example 4] provides the method of the example 1, and further comprises: optionally, the generating the effect image according to the at least two content reference images, the posture reference image, and the first corresponding relationship, comprising: determining an object mask image corresponding to each of the plurality of first objects in the posture reference image respectively, and an image region corresponding to the first object has a same display position in the object mask image and the posture reference image; and determining a second corresponding relationship between the at least two content reference images and the object mask image according to the first corresponding relationship, and generating the effect image according to the at least two content reference images, a plurality of the object mask images, and the second corresponding relationship.

According to one or more embodiments of the present disclosure, [example 5] provides the method of the example 1, and further comprises: optionally, the generating the effect image according to the at least two content reference images, the plurality of object mask images, and the second corresponding relationship, comprising: inputting the at least two content reference images and the plurality of object mask images to an effect generation model according to the second corresponding relationship, to obtain the effect image, and the effect generation model is obtained by training a diffusion model using a sample content pattern and a sample mask image.

According to one or more embodiments of the present disclosure, [example 6] provides the method of the example 1, and further comprises: optionally, the determining the object mask image corresponding to each of the plurality of first objects in the posture reference image respectively, comprising: determining a posture mask image corresponding to the posture reference image, and determining the object mask image corresponding to each of the plurality of first objects respectively according to the posture mask image.

According to one or more embodiments of the present disclosure, [example 7] provides the method of the example 1, and further comprises: optionally, the determining the object mask image corresponding to each of the plurality of first objects respectively according to the posture mask image, comprising: performing image segmentation on the posture mask image, to obtain a local mask image corresponding to each of the plurality of first objects respectively; and for each local mask image, according to display position and image size of the first object corresponding to the local mask image in the posture mask image, performing image filling on the local mask image, to obtain the object mask image corresponding to the first object.

According to one or more embodiments of the present disclosure, [example 8] provides the method of the example 1, and further comprises: optionally, before in response to the effect triggering operation, the method for effect processing further comprising: in response to a style setting operation, determining an image style corresponding to the effect image; the generating the effect image according to the at least two content reference images and the posture reference image, comprising: generating the effect image according to the at least two content reference images, the posture reference image, and the image style.

According to one or more embodiments of the present disclosure, [example 9] provides a device for effect processing, and the device for effect processing comprises: an image acquisition module, configured to, in response to an image setting operation, acquire a plurality of first images which are provided, the plurality of first images comprising at least two content reference images and at least one posture reference image, and the at least one posture reference image comprising a plurality of first objects; and an image generation module, configured to, in response to a effect triggering operation, generate an effect image according to the at least two content reference images and the posture reference image, the effect image comprising a plurality of effect objects, at least a portion of the object content in the plurality of effect objects being associated with at least a portion of the image content in the at least two content reference images; and posture information of the effect object being associated with posture information of the first object.

The above description is only the explanation of the exemplary embodiment and the applied technical principles of the present disclosure. It should be understood by those skilled in the art that the disclosure scope involved in the present disclosure is not limited to the technical solution formed by the specific combination of the above technical features, but also contains other technical solutions formed by any combination of the above technical features or their equivalent features without departing from the above disclosure concept. For example, the above features are replaced with technical features with similar functions (but not limited to) disclosed in the present disclosure to form the technical solution.

Furthermore, although the operations are depicted in a particular order, this should not be understood as requiring that these operations are performed in the particular order shown or in a sequential order. Under certain circumstances, multi-task and parallel processing may be beneficial. Likewise, although several specific implementation details are contained in the above discussion, these should not be construed as limiting the scope of the present disclosure. Some features described in the context of separate embodiments may also be combined in a single embodiment. On the contrary, various features described in the context of a single embodiment may also be implemented in a plurality of embodiments individually or in any suitable sub-combination manner.

Although the subject matter has been described by using language specific to structural features and/or method logical actions, it should be understood that the subject matter defined in the attached claims is not necessarily limited to the specific features or actions described above. Rather, the specific features and actions described above are merely example forms of implementing claims.

1. A method for effect processing, comprising:
in response to an image setting operation, acquiring a plurality of first images which are provided, the plurality of first images comprising at least two content reference images and a posture reference image, and the posture reference image comprising a plurality of first objects; and
in response to an effect triggering operation, generating an effect image according to the at least two content reference images and the posture reference image,
wherein the effect image comprises a plurality of effect objects, at least a portion of an object content in the plurality of effect objects is associated with at least a portion of an image content in the at least two content reference images, and posture information of each of the plurality of effect objects is associated with posture information of one of the plurality of first objects.

2. The method according to claim 1, wherein the generating an effect image according to the at least two content reference images and the posture reference image, comprises:
determining a first corresponding relationship between the at least two content reference images and the plurality of first objects in the posture reference image, and generating the effect image according to the at least two content reference images, the posture reference image, and the first corresponding relationship.

3. The method according to claim 2, wherein the determining the first corresponding relationship between the at least two content reference images and the plurality of first objects in the posture reference image, comprises:
in response to a relationship setting operation being input for at least one of the at least two content reference images and/or the posture reference image, determining the first corresponding relationship between the at least two content reference images and the plurality of first objects in the posture reference image.

4. The method according to claim 2, wherein the generating the effect image according to the at least two content reference images, the posture reference image, and the first corresponding relationship, comprises:
determining an object mask image corresponding to each of the plurality of first objects in the posture reference image respectively, wherein an image region corresponding to the first object has a same display position in the object mask image and the posture reference image; and
determining a second corresponding relationship between the at least two content reference images and the object mask image according to the first corresponding relationship, and generating the effect image according to the at least two content reference images, a plurality of the object mask images, and the second corresponding relationship.

5. The method according to claim 4, wherein the generating the effect image according to the at least two content reference images, the plurality of object mask images, and the second corresponding relationship, comprises:
inputting the at least two content reference images and the plurality of object mask images to an effect generation model according to the second corresponding relationship, to obtain the effect image, wherein the effect generation model is obtained by training a diffusion model using a sample content pattern and a sample mask image.

6. The method according to claim 4, wherein the determining the object mask image corresponding to each of the plurality of first objects in the posture reference image respectively, comprises:
determining a posture mask image corresponding to the posture reference image, and determining the object mask image corresponding to each of the plurality of first objects respectively according to the posture mask image.

7. The method according to claim 6, wherein the determining the object mask image corresponding to each of the plurality of first objects respectively according to the posture mask image, comprises:
performing image segmentation on the posture mask image, to obtain a local mask image corresponding to each of the plurality of first objects respectively; and
for each local mask image, according to display position and image size of the first object corresponding to the local mask image in the posture mask image, performing image filling on the local mask image, to obtain the object mask image corresponding to the first object.

8. The method according to claim 1, wherein before in response to the effect triggering operation, the method for effect processing further comprises:
in response to a style setting operation, determining an image style corresponding to the effect image; and
the generating the effect image according to the at least two content reference images and the posture reference image, comprises:
generating the effect image according to the at least two content reference images, the posture reference image, and the image style.

9. The method according to claim 1, wherein in response to an image setting operation, the acquiring a plurality of first images which are provided comprises:
in response to the image setting operation, acquiring the posture reference image; and
in response to the image setting operation, acquiring the at least two content reference images.

10. The method according to claim 9, wherein in response to the image setting operation, the acquiring the posture reference image comprises:
displaying at least one candidate posture image; and
in response to a first image selection operation being input for the at least one candidate posture image, selecting the posture reference image from the at least one candidate posture images.

11. The method according to claim 9, wherein in response to the image setting operation, the acquiring the posture reference image comprises:
in response to a first image editing operation, generating the posture reference image according to a preset posture requirement.

12. The method according to claim 9, wherein in response to the image setting operation, the acquiring the posture reference image comprises:
in response to a first image screenshot operation, capturing the posture reference image from a specified page.

13. The method according to claim 9, wherein in response to the image setting operation, the acquiring the at least two content reference images which are provided comprises:
displaying at least two candidate content images; and
in response to a second image selection operation being input for the content reference image, selecting at least two candidate content images from the at least two candidate content images.

14. The method according to claim 9, wherein in response to the image setting operation, the acquiring the at least two content reference images comprise:
shooting at least a preset number of reference content images; and
in response to a shooting operation being input for the content reference image, selecting at least two content reference images from at least the preset number of the reference content images.

15. The method according to claim 9, wherein in response to the image setting operation, the acquiring the at least two set content reference images comprises:
in response to a second image screenshot operation, capturing at least two content reference images from a specified page.

16. An apparatus for effect processing, comprising:
one or more processors; and
a non-transitory memory with instructions thereon,
wherein the instructions upon execution by the one or more processors, cause the one or more processors to perform a method for effect processing, and the method for effect processing comprises:
in response to an image setting operation, acquiring a plurality of first images which are provided, the plurality of first images comprising at least two content reference images and a posture reference image, and the posture reference image comprising a plurality of first objects; and
in response to an effect triggering operation, generating an effect image according to the at least two content reference images and the posture reference image,
wherein the effect image comprises a plurality of effect objects, at least a portion of an object content in the plurality of effect objects is associated with at least a portion of an image content in the at least two content reference images, and posture information of each of the plurality of effect objects is associated with posture information of one of the plurality of first objects.

17. The apparatus according to claim 16, wherein the generating an effect image according to the at least two content reference images and the posture reference image, comprises:
determining a first corresponding relationship between the at least two content reference images and the plurality of first objects in the posture reference image, and generating the effect image according to the at least two content reference images, the posture reference image, and the first corresponding relationship.

18. The apparatus according to claim 17, wherein the determining the first corresponding relationship between the at least two content reference images and the plurality of first objects in the posture reference image, comprises:
in response to a relationship setting operation being input for at least one of the at least two content reference images and/or the posture reference image, determining the first corresponding relationship between the at least two content reference images and the plurality of first objects in the posture reference image.

19. The apparatus according to claim 17, wherein the generating the effect image according to the at least two content reference images, the posture reference image, and the first corresponding relationship, comprises:
determining an object mask image corresponding to each of the plurality of first objects in the posture reference image respectively, wherein an image region corresponding to the first object has a same display position in the object mask image and the posture reference image; and
determining a second corresponding relationship between the at least two content reference images and the object mask image according to the first corresponding relationship, and generating the effect image according to the at least two content reference images, a plurality of the object mask images, and the second corresponding relationship.

20. A non-transitory computer-readable storage medium, comprising computer executable instructions,
wherein the computer executable instructions, upon running on a computer, cause the computer to perform a method for effect processing, and the method for effect processing comprises:
in response to an image setting operation, acquiring a plurality of first images which are provided, the plurality of first images comprising at least two content reference images and a posture reference image, and the posture reference image comprising a plurality of first objects; and
in response to an effect triggering operation, generating an effect image according to the at least two content reference images and the posture reference image,
wherein the effect image comprises a plurality of effect objects, at least a portion of an object content in the plurality of effect objects is associated with at least a portion of an image content in the at least two content reference images, and posture information of each of the plurality of effect objects is associated with posture information of one of the plurality of first objects.
